(19) United States
(12) Patent Application Publication
(10) Pub. No.: US 2003/0038757 A1
(43) Pub. Date: Feb. 27, 2003

(54) Plasma display apparatus and driving method thereof

(76) Inventor: Shigeru Kojima, Kanagawa (JP)

Correspondence Address: Robert J. Depke, Holland & Knight LLP, Suite 800, 55 West Monroe Street, Chicago, IL, 60603-5144, US

(21) Appl. No.: 10/218,359

(22) Filed: Aug. 14, 2002

(30) Foreign Application Priority Data
Aug. 24, 2001 (JP) P2001-254798

(51) Int. Cl. G09G 3/28

(52) U.S. Cl. 345/60

(57) ABSTRACT

A plasma display apparatus according to the present invention includes a dischargeable gas sealed between a pair of substrates joined to each other. A first electrode Y and a second electrode X are formed on one substrate in correspondence with each scanning line. A third electrode H is formed on the other substrate in correspondence with each data line. The first electrode Y, the second electrode X, and the third electrode H are driven to sequentially write data at an intersection of each scanning line and each data line and retain the data at the intersection, and thereby display one field of image. Waveforms of driving signals applied to the first electrode Y and the second electrode X are interchanged between fields or within a field, and thereby alternating-current driving is performed. Thus, damage to a dielectric covering the electrodes and a protective film on the dielectric is minimized, whereby decrease in reliability can be prevented.

### BACKGROUND OF THE INVENTION

The present invention relates to a plasma display apparatus and a driving method thereof. More particularly, the present invention relates to a technique for alternating driving signals applied to a pair of plasma discharge electrodes. The present invention also relates to a driving pulse adjusting technique for suppressing erroneous discharge in an alternating-current driving type plasma display apparatus of a three-electrode structure.

Various flat panel type display apparatus have been developed as image display apparatus to replace currently predominant cathode-ray tubes (CRTs). Among others, the plasma display apparatus has advantages of making it relatively easy to increase screen size and widen a viewing angle, having excellent resistance to environmental factors such as the temperature, magnetism, vibration and the like, having a long life, and the like. The plasma display apparatus is expected to be applied to wall-hung televisions for household use and to large information terminal apparatus for public use.

The plasma display apparatus applies a voltage to a discharge cell in which a discharge gas such as an inert gas is sealed in a discharge space, excites a fluorescent layer within the discharge cell with vacuum ultraviolet rays generated from glow discharge in the discharge gas, and thereby obtains light emission. Thus, each individual discharge cell is driven on principles similar to those of a fluorescent light. A large number of discharge cells are brought together to form pixels, whereby one display screen is formed. Each discharge cell is driven to be turned on or off, and thus produces two-gradation-step display in principle. Plasma display apparatus are roughly classified into a direct-current driving type (DC type) and an alternating-current driving type (AC type) according to the method of applying a voltage to a discharge cell. The AC type plasma display apparatus is suitable for higher resolution because it suffices to form in a stripe manner partitions serving to divide individual discharge cells within the display screen. In addition, since the surfaces of discharge electrodes are covered with a dielectric layer, the electrodes resist wear. The AC type plasma display apparatus therefore has an advantage of having a long life.

A common alternating-current driving sequence of the plasma display apparatus includes a resetting operation, an addressing operation, and a sustaining operation. The reset operation resets a scanning line by applying a driving signal to a pair of electrodes. The next addressing operation addresses the reset scanning line to write data therein. The sustaining operation applies a driving signal between the pair of discharge electrodes to repeatedly sustain light emission according to the data written in the addressing period. With the conventional alternating-current driving method, however, polarity of the driving signal in the sustaining operation is changed between the pair of electrodes, but a relation in polarity of the driving signals in the resetting operation and the addressing operation between the pair of discharge electrodes is fixed at all times. Hence, with the conventional alternating-current driving method, a direct current is added in terms of an average over a long period of time. Thus, a charge may be captured in a trap in the dielectric layer covering the discharge electrodes, causing degradation. In addition, as a result of the charge being captured, driving voltage may be varied. Thus, with the conventional alternating-current driving method, a direct current is added over time, and therefore a charge may be accumulated to degrade the dielectric film. The conventional alternating-current driving method therefore has a problem in terms of long-term reliability.

The AC type plasma display apparatus generally has a three-electrode structure. Such a plasma display apparatus has a dischargeable gas sealed between a pair of substrates joined to each other. A first electrode and a second electrode (a scanning electrode Y and a sustaining electrode X) are formed on one substrate in correspondence with each scanning line, while a third electrode (a data electrode H) is formed on the other substrate in correspondence with each data line.

The first electrode, the second electrode, and the third electrode are driven to sequentially write data at an intersection of each scanning line and each data line and retain the data at the intersection, whereby an image is displayed. As described above, a concrete driving sequence includes a resetting operation, an addressing operation, and a sustaining operation. The first reset operation resets scanning lines to write white level simultaneously. The next addressing operation sequentially addresses each of the scanning lines to change the written white level to black level according to the data. The method of changing the white level (on level) to the black level (off level) in the addressing operation is referred to as an erasing method. Then, the sustaining operation retains luminance corresponding to the written white level and black level. Specifically, when the white level has been written, light emission is repeated to maintain luminance at a high level. When the black level has been written, on the other hand, light emission is not performed to maintain luminance at a low level.

In an ordinary plasma display apparatus in which a distance between the first electrode and the second electrode is set at about 70 μm, devices of combining a gradient pulse and a rectangular pulse and the like have been provided for the resetting operation. In the sustaining operation, when one field is divided into a plurality of sub-fields for gradation display, the order of the sub-fields may be changed. Alternatively, an adjusting pulse may be inserted in place of a resetting pulse after sustained light emission. However, it cannot be said that such devices completely eliminate screen flicker specific to the plasma display apparatus, which flicker is caused by erroneous discharge. In a case of an RGB pixel configuration in which voltages for driving discharge cells are different, size of the cells may be changed or some device may be provided for composition of the fluorescent materials to make driving voltages for RGB equal to each other.

A “short gap plasma display apparatus” has been developed which has a still shorter distance between the first electrode and the second electrode than the conventional plasma display apparatus. The “short gap type” makes discharge easier than discharge cells having normal electrode intervals. Therefore, when driving is performed in the normal sequence including the resetting operation, the addressing operation, and the sustaining operation, discharge may occur even at the black level in the sustaining operation. This erroneous discharge is considered to be involved in the flicker specific to the plasma display apparatus (PDP). The erroneous discharge is thought to be caused by an unnecessary wall charge that is actually formed by erasing discharge when selective erasing is performed to write black level in the addressing operation.

### SUMMARY OF THE INVENTION

In view of the problems of the conventional techniques, it is an object of the present invention to provide a plasma display apparatus and a driving method thereof that can convert driving signals applied to a pair of electrodes into an alternating current on an average over a long period of time. The following means are provided to achieve the object. There is provided a plasma display apparatus including: a panel having a dischargeable gas sealed between a pair of substrates joined to each other, a first electrode and a second electrode formed on one substrate in correspondence with each scanning line, and a third electrode formed on the other substrate in correspondence with each data line; and a driving unit for driving the first electrode, the second electrode, and the third electrode, sequentially writing data at an intersection of each scanning line and each data line and retaining the data at the intersection, and thereby displaying one field of image; wherein the driving unit performs alternating-current driving by interchanging waveforms of driving signals applied to the first electrode and the second electrode between fields or within a field.

Specifically, the driving unit first applies the driving signals to the first electrode and the second electrode to reset the scanning line, then addresses the reset scanning line to write data therein, and thereafter retains the written data; and the waveforms of the driving signals are interchanged at least at the times of resetting and addressing the scanning line.

Preferably, to write and retain multiple-gradation-step data formed by a plurality of weighted bits, the driving unit divides one field into a plurality of sub-fields corresponding to the plurality of bits; and the driving unit performs the alternating-current driving by interchanging the waveforms of the driving signals applied to the first electrode and the second electrode in each of the sub-fields.

It is another object of the present invention to suppress erroneous discharge in an AC type plasma display apparatus having a three-electrode structure, and to thus improve image quality. The following means are provided to achieve the object. There is provided a plasma display apparatus including: a panel including a dischargeable gas sealed between a pair of substrates joined to each other, a first electrode and a second electrode formed on one substrate in correspondence with each scanning line, and a third electrode formed on the other substrate in correspondence with each data line; and a driving unit for driving the first electrode, the second electrode, and the third electrode, sequentially writing data at an intersection of each scanning line and each data line and retaining the data at the intersection, and thereby displaying an image; wherein the driving unit applies driving signals to the first electrode and the second electrode, and thereby first performs a reset operation for resetting scanning lines to write white level simultaneously, then performs an addressing operation for sequentially addressing each of the scanning lines to change the written white level to black level according to data, and thereafter performs a sustaining operation for retaining luminance corresponding to the written white level and black level; and the driving unit applies a driving signal for discharge stabilization between the addressing operation and the sustaining operation. Preferably, the driving unit applies the driving signal for discharge stabilization to only scanning lines in which the black level is written in the addressing operation. In this case, the driving unit may apply the driving signal for discharge stabilization when luminance of the image is low, and may not apply the driving signal for discharge stabilization when the luminance of the image is high. Alternatively, the driving unit may apply the driving signal for discharge stabilization when contrast of the image is to be enhanced.

According to the present invention, the alternating-current driving is performed by interchanging the waveforms of the driving signals applied to the first electrode and the second electrode between fields or within a field. Specifically, the waveforms of the driving signals are interchanged at least at the times of resetting and addressing the scanning line, whereby a bias voltage in terms of an average over a long period of time is canceled, and thus alternation of the driving signals is realized. Thus, degradation of a dielectric film covering the first electrode and the second electrode is prevented, whereby the life of the panel is lengthened. Also, non-uniformity of wall charges distributed on a protective film is reduced to realize uniform distribution of wall charges within the panel, whereby flicker of a displayed image is reduced.

In addition, according to the present invention, the driving pulse for discharge stabilization is applied between the addressing operation and the sustaining operation. The adjusting pulse removes unnecessary wall charge that causes erroneous discharge. The unnecessary wall charge is a charge that cannot be removed in the addressing operation. The plasma display apparatus carries out a driving sequence including a resetting operation, an addressing operation, and a sustaining operation. The resetting operation forms wall charge in the whole of the screen. The addressing operation selectively removes the wall charge from discharge cells where black level is to be written. However, the wall charge cannot be removed completely in some parts, and consequently unnecessary charge may be left. This unnecessary charge can cause erroneous discharge, which means that light is emitted even at the black level during the sustaining period. Accordingly, the present invention applies the adjusting pulse in a period after the addressing operation and before the sustaining operation, thereby removing the unnecessary wall charge and thus suppressing the erroneous discharge.

### BRIEF DESCRIPTION OF THE DRAWINGS

FIG. 1 is an exploded perspective view of structure of a plasma display apparatus according to the present invention;

FIG. 2 is a schematic diagram showing an electrode configuration of the plasma display apparatus according to the present invention;

FIG. 3 is a timing chart of a driving method of a conventional plasma display apparatus;

FIG. 4 is a timing chart of a driving method of the plasma display apparatus according to the present invention;

FIG. 5 is a timing chart of a sub-field method;

FIG. 6 is a timing chart of a reference example of a driving method of a plasma display apparatus; and

FIG. 7 is a timing chart of a driving method of the plasma display apparatus according to the present invention.

### DETAILED DESCRIPTION OF THE PREFERRED EMBODIMENTS

A preferred embodiment of the present invention will hereinafter be described in detail with reference to the drawings.

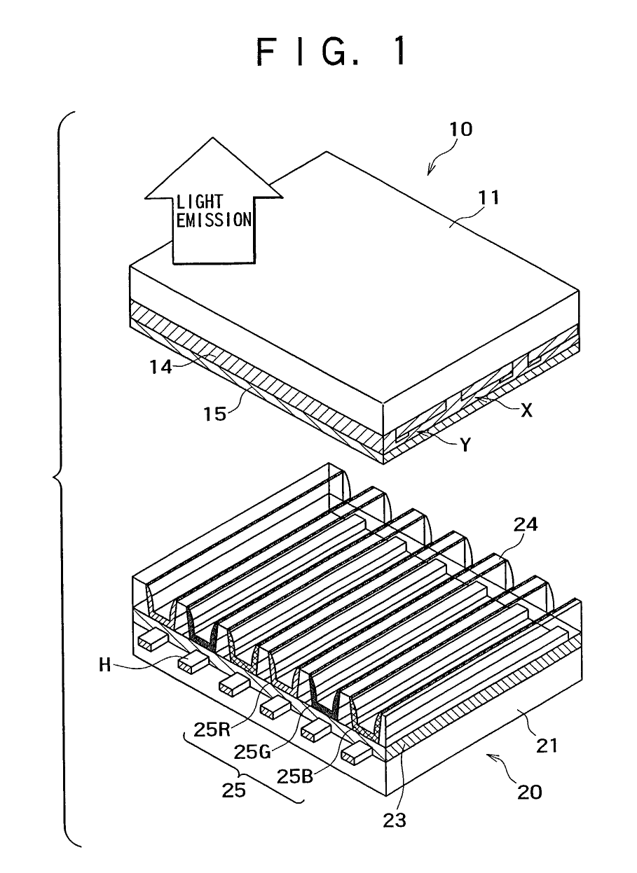

A plasma display apparatus according to the present invention is of an AC type and of a so-called three-electrode type. The plasma display apparatus according to the present invention as shown in FIG. 1 is formed with a front panel 10 and a rear panel 20 joined to each other at peripheral portions thereof. Light emission of a fluorescent layer 25 on the rear panel 20 is observed through the front panel 10.

The front panel 10 includes: a transparent glass substrate 11; a plurality of pairs of scanning electrodes Y and sustaining electrodes X formed of transparent conductive material and disposed in a stripe manner on the glass substrate 11; a dielectric layer 14 of dielectric material formed on the glass substrate 11 so as to cover the electrodes; and a protective film 15 of MgO or the like formed on the dielectric layer 14. The dielectric layer 14 is formed of a SiO₂ film, for example. Bus electrodes of a metallic material having a low electric resistivity are formed on the scanning electrodes Y of the transparent conductive material to lower impedance of the scanning electrodes Y. Similarly, bus electrodes of a metallic material having a narrow width are formed on the sustaining electrodes X of the transparent conductive material. A gap between a scanning electrode Y and a sustaining electrode X is 1 to 100 μm. A pair of a scanning electrode Y and a sustaining electrode X has an arrangement pitch of 150 to 1200 μm.

The rear panel 20 includes: a glass substrate 21; a plurality of data electrodes H disposed in a stripe manner on the glass substrate 21; a dielectric material layer 23 formed on the glass substrate 21 including the data electrodes H; insulative partitions 24 on the dielectric material layer 23, the partitions extending in regions between adjacent data electrodes H in parallel with the data electrodes H; and a fluorescent layer 25 disposed extending from portions over the dielectric material layer 23 up to portions over side wall surfaces of the partitions 24. In a case where the AC type plasma display apparatus produces a color display, the fluorescent layer 25 is formed of a red fluorescent layer 25R, a green fluorescent layer 25G, and a blue fluorescent layer 25B. The red fluorescent layer 25R, the green fluorescent layer 25G, and the blue fluorescent layer 25B are disposed in predetermined order. Since FIG. 1 is an exploded perspective view, top portions of the partitions 24 on the rear panel 20 side are in practice in contact with the protective film 15 on the front panel 10 side. An area where a pair of a scanning electrode Y and a sustaining electrode X overlaps a data electrode H situated between two partitions 24 corresponds to a discharge cell. The inside of the discharge space enclosed by the adjacent partitions 24, the fluorescent layer 25, and the protective film 15 is filled with a discharge gas such as an ionizable rare gas or the like. The front panel 10 and the rear panel 20 are joined to each other at the peripheral portions thereof by using a frit glass. The partitions 24 have a height of 50 to 200 μm. A groove sandwiched between adjacent partitions 24 has a width of 100 to 400 μm.

A row direction in which a projection of the scanning electrodes Y and the sustaining electrodes X extends is perpendicular to a column direction in which a projection of the data electrodes H extends. An area where a pair of a scanning electrode Y and a sustaining electrode X perpendicularly intersects a set of fluorescent layers 25R, 25G, and 25B emitting light of three primary colors corresponds to one pixel. Because a glow discharge occurs between a pair of a scanning electrode Y and a sustaining electrode X, the AC plasma display apparatus of this type is referred to as a “surface discharge type.”

The plasma display apparatus of the surface discharge type has a dischargeable gas enclosed between the pair of substrates 11 and 21 joined to each other as described above, and has a three-electrode structure with electrodes formed on each of the substrates. Specifically, a scanning electrode Y and a sustaining electrode X, or a first electrode and a second electrode corresponding to each scanning line extending in the row direction are formed on one substrate 11, while a data electrode H, or a third electrode corresponding to each data line extending in the column direction is formed on the other substrate 21. A dot is formed at an intersection of each scanning line and each data line, and a set of three RGB dots forms one pixel.

In general, a gas sealed in the discharge space formed between the pair of glass substrates 11 and 21 is formed by mixing an inert gas such as neon, helium, argon, krypton or the like with about 4% xenon gas, for example. A total pressure of the mixed gas is about 6×10⁴ Pa to 7×10⁴ Pa, and a partial pressure of the xenon is about 3×10³ Pa, for example.

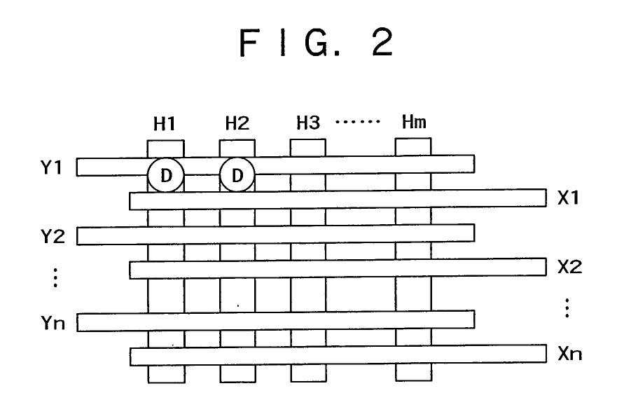

FIG. 2 schematically shows the three-electrode structure of the plasma display apparatus shown in FIG. 1. In correspondence with scanning lines along the row direction (horizontal direction), n scanning electrodes Y1 to Yn are formed. In this case, n denotes the number of scanning lines. Sustaining electrodes X1 to Xn are formed in parallel with the scanning electrodes Y1 to Yn. On the other hand, m data electrodes H1 to Hm are formed along data lines in the column direction (vertical direction). In this case, m denotes the number of data lines. A dot D is formed at an intersection of each of the m data lines and each of the n scanning lines. Application of driving signals to the scanning electrode Y, the sustaining electrode X, and the data electrode H in a predetermined sequence causes plasma discharge. The fluorescent material is thereby irradiated with resulting ultraviolet radiation to emit light and thus enable display of an image.

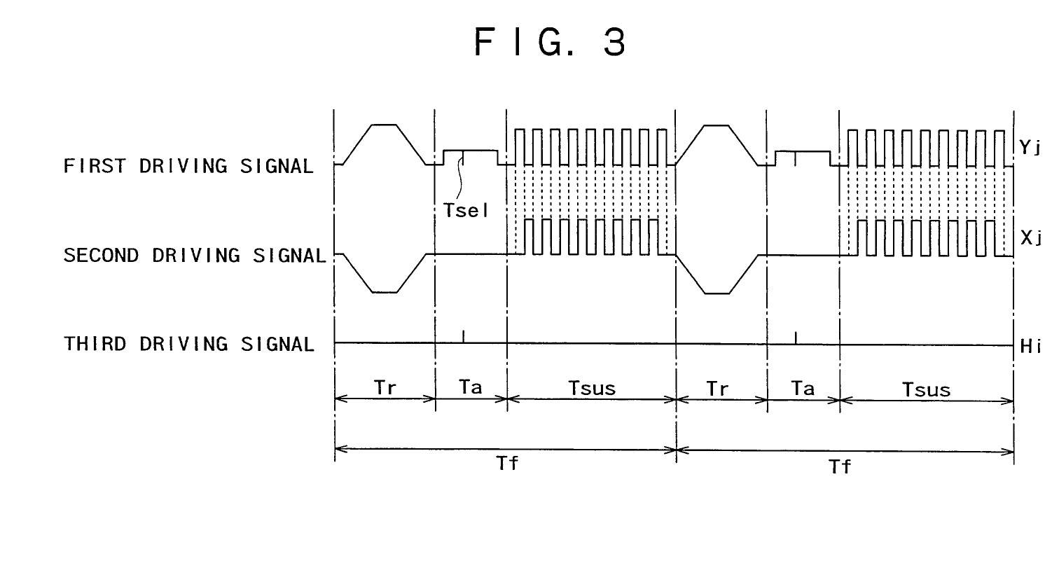

FIG. 3 is provided for reference to clarify the background of the present invention. FIG. 3 is a timing chart schematically illustrating a common driving method of the plasma display apparatus of the three-electrode type shown in FIG. 2. The timing chart shows driving waveforms when attention is directed to a dot D situated at an ith column and a jth row. A driving circuit (not shown) connected to the panel shown in FIG. 2 applies a first driving signal to a scanning electrode Yj, applies a second driving signal to a sustaining electrode Xj, and applies a third driving signal to a data electrode Hi. In the example of FIG. 3, two-gradation-step display is performed using the whole of one field period Tf.

The field period Tf is divided into a resetting period Tr, an addressing period Ta, and a sustaining period Tsus. First, in the resetting period Tr, before data is written to each dot, charge within the panel is discharged to reset the whole screen to a uniform state. Alternatively, the whole screen may be reset to a uniform state by charging the inside of the panel with electric charges. For this purpose, driving signals are applied to all of the scanning electrodes Y and the sustaining electrodes X in the resetting period Tr. In the next addressing period Ta, line-sequential scanning is performed for all of the scanning lines to select each of the scanning lines. In order to select a scanning line of the jth row, a first driving signal in the form of a pulse is applied to the scanning electrode Yj. A period when one scanning line is selected is denoted by Tsel. At this time, in synchronism with the line-sequential scanning of the scanning line, a third driving signal is supplied to the data electrode H. For example, when data of 1 is to be written to the dot at the jth row and the ith column, a third driving signal as shown in FIG. 3 is applied as a pulse to the data electrode Hi. On the other hand, when data of 0 is to be written to the dot at the jth row and the ith column, no pulse is applied. Thus, the addressing period Ta is a period when the scanning lines are addressed and selected. The selection is repeated by the number of scanning lines of the display, and the third driving signal corresponding to binary information 0 or 1 of the image is applied to the data electrode H in synchronism with the selection. The addressing period Ta=Tsel×n. The driving signal of ON=1 or OFF=0 is applied to the data electrode Hi in correspondence with the display dot Dji, and the first driving signal is applied to the scanning electrode Yj in correspondence with the position of the dot Dji. After completion of line-sequential scanning for one screen in the column direction (vertical direction), the driving processing enters the sustaining period Tsus.

In the sustaining period Tsus, light emitting/non-emitting operation is performed according to a state of ON/OFF written in the addressing period Ta. When ON=1 has been written in the addressing period Ta, light emission is sustained to obtain a desired luminance. On the other hand, when OFF=0 has been written in the addressing period, the non-emitting state is sustained. In the sustaining period Tsus, a driving signal in the form of a pulse is applied between the scanning electrode Y and the sustaining electrode X, so that light emission is repeated in response to the pulse. As described above, the plasma display apparatus basically performs ON/OFF driving of a dot, and hence produces a two-gradation-step display.

FIG. 3 shows a driving sequence for two fields. As is clear from the timing chart, polarity of each of the driving signals applied to the scanning electrode Y, the sustaining electrode X, and the data electrode H is not varied between the first field period and the second field period. Potential relations at the times of the resetting operation and the addressing operation are not changed between the first field period and the second field period. During the resetting period Tr in each of the first field and the second field, a first driving signal of positive polarity is applied to the scanning electrode Y, while a second driving signal of negative polarity is applied to the sustaining electrode X. During the next addressing period Ta, a first driving signal of one polarity is applied to the scanning electrode Y, while the sustaining electrode X side is maintained at a ground potential. In an actual panel, the resetting operation and the addressing operation generate plasma and cause light emitting discharge. Thereby, a large amount of charge is generated and accumulated on the dielectric film and the protective film on the scanning electrode and the sustaining electrode. Electrons are captured on the protective film of one electrode, while rare gas ions are captured on the protective film of the other electrode. The captured charges adversely affect reliability and the like.

In the sustaining period Tsus generally referred to as a display period and contributing to actual screen luminance, alternating-current driving is performed between the pair of electrodes X and Y as shown in the timing chart of FIG. 3. The amount of charges accumulated in this period is therefore considered to be small. On the other hand, in the resetting operation and the addressing operation, the potential relations of the sustaining electrode X and the scanning electrode Y are always the same, and therefore on an average over a long period of time, direct currents are applied to the sustaining electrode X and the scanning electrode Y. Hence, during driving over a long period of time, mobile metal ions can be moved in the dielectric film, or a charge can be captured in a trap within the dielectric film. This means a variation in an operating point of panel driving. Mobile metal ions are considered to have other adverse effects. Specifically, mobile metal ions tend to be collected on a defect-prone interface between the dielectric film and the protective film on the scanning electrode Y side. From a viewpoint of ionization tendency, when the mobile metal ions are sodium, the sodium removes oxygen from Mg, an element forming the protective film, thus resulting in a change in properties of the protective film.

The dielectric film generally used in the plasma display apparatus is a glass dielectric formed by a CVD method or a sputtering method or a glass dielectric formed by a printing method which glass dielectric has SiO₂ as a main component thereof. The dielectric film tends to take in moisture. In present conditions, to form a dielectric film with a film thickness of 10 μm or less requires the CVD method or the sputtering method. An SiO₂ film formed by the sputtering method, in particular, generally has therein a contaminating metal such as an alkali metal or a transition metal, and hence often has a defect. Therefore, when the SiO₂ film is used as the dielectric film in the AC driving type plasma display apparatus, the dielectric film is affected by electrons or positive ions generated in plasma. In the period of the sustaining operation, positive polarity and negative polarity alternate with each other between the pair of electrodes, thus basically representing alternating-current driving and therefore not presenting much of a problem.

However, the polarity relation is not changed in the resetting operation and the addressing operation. This affects reliability in driving over a long period of time. A charge in the film hinders uniform formation of wall charge, the movement of mobile metal ions in the film varies the operating point, and other varying factors result.

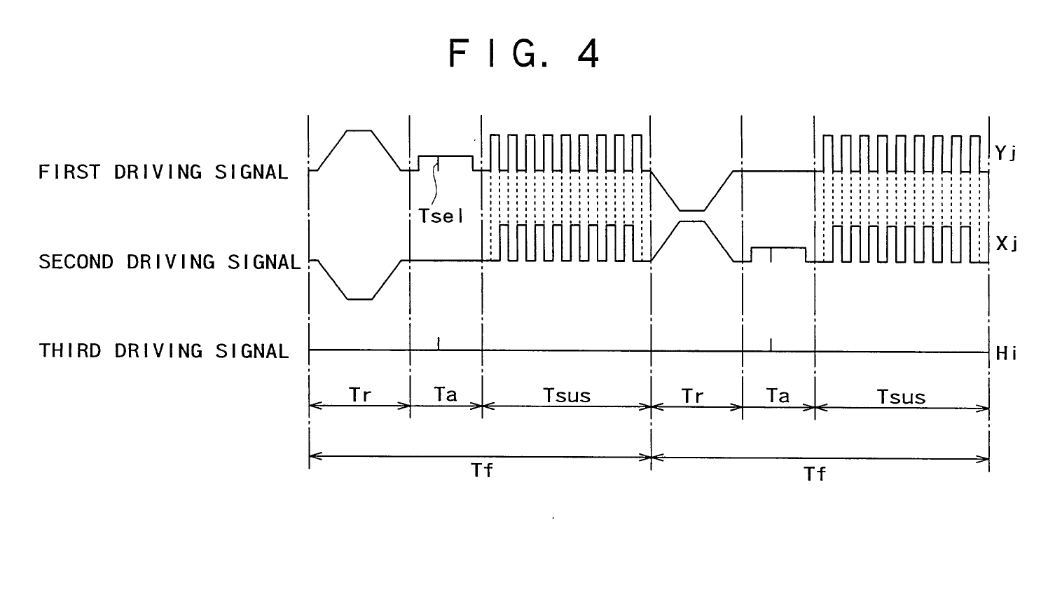

In order to avoid the above problem, it is important to employ a driving method close to alternating-current driving, in which voltages applied to the scanning electrode Y and the sustaining electrode X are interchanged in each field. FIG. 4 shows such a driving sequence according to the present invention. In the example shown in FIG. 4, waveforms of driving signals applied to the scanning electrode Y and the sustaining electrode X are interchanged in each field period Tf. By changing roles of the scanning electrode Y and the sustaining electrode X in each field for perfect alternation, it is possible to minimize the effects of metal ions in the dielectric film and thus avoid degradation. By interchanging driving waveforms of the scanning electrode Y and the sustaining electrode X in each field, it is possible to minimize the effects on the dielectric film and the protective film.

As described above, the plasma display apparatus basically makes two-gradation-step ON/OFF display. A sub-field method is employed for the plasma display apparatus to make multiple-gradation-step display. The present invention is also applicable to the sub-field method. FIG. 5 illustrates multiple-gradation-step display by a common sub-field method. In the case of two-gradation-step display, data written to each dot is formed by a single bit 0 or 1. In the case of multiple-gradation-step display, on the other hand, multi-bit data formed by a plurality of bits that are given weights decreasing in steps from a highest-order digit toward a lowest-order digit is written to each dot. In the sub-field method, one field period Tf is divided into a plurality of sub-fields corresponding to the plurality of bits. In the example shown in FIG. 5, the multiple-gradation-step data is eight-gradation-step data from a highest-order bit B7 to a lowest-order bit B0, and the field period Tf is divided into eight sub-field periods T7, T6, T5, . . . , and T0. Each of the bits is written in the corresponding sub-field, and a driving signal having a number of pulses corresponding to the weight of the bit is applied between the scanning electrode and the sustaining electrode to retain the bit during the sustaining period. In the example shown in FIG. 5, the highest-order bit B7 is written and retained in the sub-field period T7; the next bit B6 is written in the next sub-field period T6; and thereafter the remaining bits down to the lowest-order bit B0 are sequentially written within the field period Tf.

A driving sequence including a resetting operation, an addressing operation, and a sustaining operation is performed in each sub-field to write a corresponding bit. When attention is directed to the first sub-field T7, for example, the whole of the screen is reset in a resetting period Tr, the highest-order bit B7 is written in an addressing period Ta, and the written bit data B7 is retained in a sustaining period Tsus. A dot in which B7=1 is written repeats pulse light emission, whereas a dot in which B7=0 is written remains in a non-emitting state. A similar sub-field driving sequence is repeated in each of the following periods T6, T5, . . . , and T0. In the sub-field periods T, length of time of the period Tr+Ta that does not contribute to real luminance is the same, but the effective period Tsus that contributes to the luminance differs. Specifically, a driving signal having a number of pulses according to the weight of the bit is applied in each sub-field. The most pulses are applied for the highest-order bit; half the number of pulses are applied for the next bit B6; and the number of pulses is halved for each of the following bits. When a driving signal having a fixed pulse frequency is applied between the scanning electrode and the sustaining electrode in all of the sub-field periods, the sustaining period Tsus simply has a time length corresponding to the weight of the corresponding bit. Hence, the sub-field period T, which is a sum of Tr, Ta, and Tsus, is shortened from T7 to T0, for example, from the highest-order bit toward the lowest-order bit.

In the example shown in FIG. 5, when the number of gradation steps is 256 represented by 8 bits, for example, the predetermined driving sequence is repeated as a sub-field eight times within the actual field period Tf, and light is emitted for the weighted sustaining periods Tsus. Luminous luminance per pulse is constant. By extending length of time of the sustaining period according to the weight in each sub-field, the effects are visually integrated over one field period Tf, and are thereby perceived as a luminance level.

Also in such a sub-field method, alternating-current driving can be performed by interchanging waveforms of driving signals applied to the scanning electrode and the sustaining electrode in each sub-field. By interchanging the waveforms of the driving signals at least at the times of resetting and addressing the scanning line, perfect alternation over a long period of time can be realized.

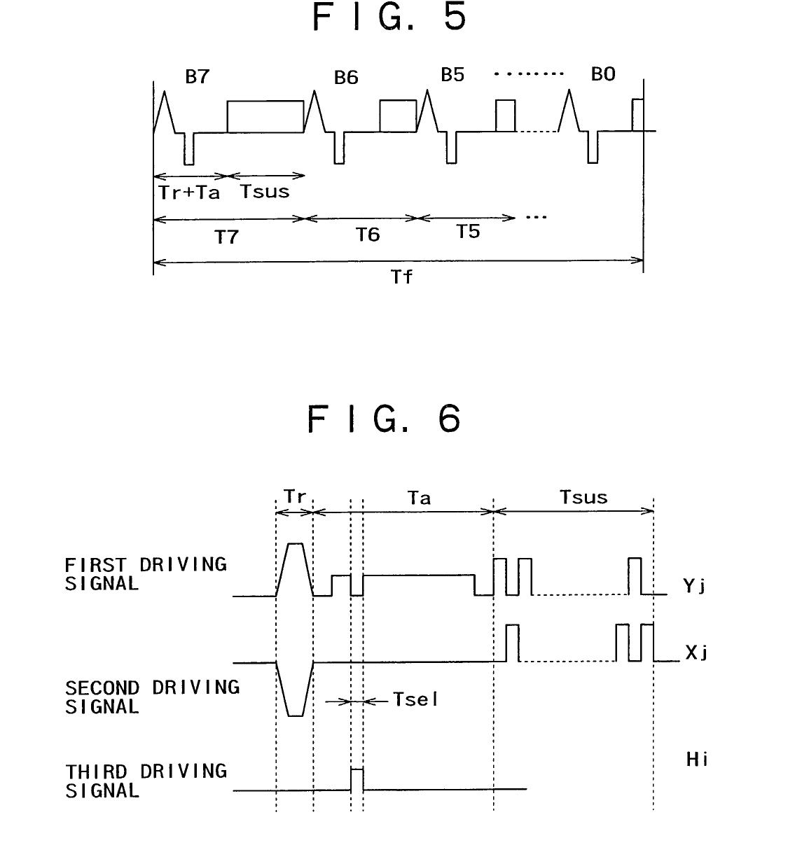

Another aspect of the present invention will next be described. Prior to the description, the background of the invention will be clarified with reference to FIG. 6. FIG. 6 is a timing chart as a reference schematically illustrating a common driving method of the plasma display apparatus of the three-electrode type shown in FIG. 2. The timing chart shows driving waveforms when attention is directed to a dot D situated at an ith column and a jth row. A driving circuit (not shown) connected to the panel shown in FIG. 2 applies a first driving signal to a scanning electrode Yj, applies a second driving signal to a sustaining electrode Xj, and applies a third driving signal to a data electrode Hi.

The driving sequence is divided into a resetting period Tr, an addressing period Ta, and a sustaining period Tsus. First, in the resetting period Tr, before data is written to each dot, the whole screen is reset to a uniform state by charging the whole of the inside of the panel with electric charges. For this purpose, driving signals including reset pulses are applied to all of the scanning electrodes Y and the sustaining electrodes X in the resetting period Tr. In the next addressing period Ta, line-sequential scanning is performed for all of the scanning lines to select each of the scanning lines. In order to select a scanning line of the jth row, a first driving signal in the form of a pulse is applied to the scanning electrode Yj. A period when one scanning line is selected is denoted by Tsel, and is equal to pulse width of the first driving signal. At this time, in synchronism with the line-sequential scanning of the scanning line, a third driving signal is supplied to the data electrode H. For example, when data of black level (off) is to be written to the dot at the jth row and the ith column, a third driving signal as shown in FIG. 6 is applied as a pulse to the data electrode Hi. The wall charges generated in the resetting period are thereby selectively erased. On the other hand, when data of white level (on) is to be written to the dot at the jth row and the ith column, no pulse is applied. The wall charges are thereby left as they are. Thus, the addressing period Ta is a period when the scanning lines are addressed and selected. The selection is repeated by the number of scanning lines of the display, and the third driving signal corresponding to binary information of black or white of the image is applied to the data electrode H in synchronism with the selection. The addressing period Ta=Tsel×n. The third driving signal including a pulse is applied to the data electrode Hi in correspondence with the display dot Dji, and the first driving signal is applied to the scanning electrode Yj in correspondence with the position of the dot Dji. After completion of line-sequential scanning for one screen in the column direction (vertical direction), the driving processing enters the sustaining period Tsus.

In the sustaining period Tsus, light emitting/non-emitting operation is performed according to a state of white/black written in the addressing period Ta. When white level has been written in the addressing period Ta, light emission is sustained to obtain a desired luminance. On the other hand, when black level has been written in the addressing period, the non-emitting state is sustained. In the sustaining period Tsus, a driving signal in the form of a pulse is applied between the scanning electrode Y and the sustaining electrode X, so that light emission is repeated in response to the pulse. As described above, the plasma display apparatus basically performs ON/OFF driving of a dot, and hence produces a two-gradation-step display.

Since a plasma display apparatus of a “short gap type” having a short interval between a scanning electrode and a sustaining electrode facilitates discharge, driving in the normal sequence as shown in FIG. 6 increases the light emission of a white-level dot in response to a first pulse in the sustaining operation. However, application of the sustaining pulse may cause erroneous discharge even in a dot where black level is written. This indicates that a voltage effectively higher than a sustaining voltage is applied to the dot, thus causing the erroneous discharge. The reason for this is considered to be existence of an excessive wall charge causing the erroneous discharge in the dot where black level is written. The excessive wall charge exists because at the time of the addressing operation, a pulse for erasing wall charge to write black level is applied to cause discharge, but actually an unnecessary wall charge is formed. Alternatively, it may be considered that the excessive wall charge exists because the wall charge cannot be removed completely by the selective erasing, thus leaving an unnecessary wall charge. The unnecessary wall charge is also considered to be a cause of flicker specific to PDPs.

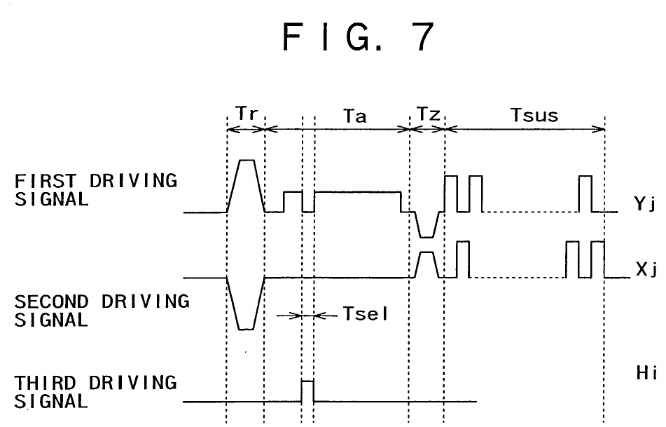

FIG. 7 is a timing chart of a driving method of the plasma display apparatus according to the present invention for dealing with the above problem. As shown in FIG. 7, the driving sequence includes a resetting operation, an addressing operation, a sustaining operation, and an adjusting operation for removing the unnecessary wall charge. Specifically, the adjusting operation for removing the unnecessary charge is inserted after the addressing operation and before the sustaining operation. In an adjusting period Tz of the adjusting operation, a pulse is applied between the scanning electrode Y and the sustaining electrode X to remove the wall charge left in the addressing operation. Unlike the resetting operation, the adjusting operation does not require application of the same adjusting pulse to all scanning lines, or does not necessarily require discharge; it suffices only to remove the excessive wall charge. Voltage level of the adjusting pulse is preferably 80 V or lower, which does not cause erasing discharge. Pulse width of the adjusting pulse is preferably 12 μSec or less.

As described above, the present invention applies the driving signal for discharge stabilization (for adjusting the wall charge) between the addressing operation and the sustaining operation. Preferably, the driving signal for adjusting the wall charge is applied to only scanning lines in which black level is written in the addressing operation. In addition, the driving signal for adjusting the wall charge is applied when the luminance of the image is low, and the driving signal for adjusting the wall charge may not be applied when the luminance of the image is high. Furthermore, the application of the driving signal for adjusting the wall charge is highly effective especially when contrast of the image is to be enhanced.

As described above, according to the present invention, the waveforms of the driving signals applied to the pair of discharge electrodes are interchanged between fields or within a field when alternating-current driving of the plasma display apparatus is performed. It is thereby possible to minimize damage to the dielectric covering the electrodes and the protective film on the dielectric, and to thus prevent decrease in reliability. Screen flicker due to a failure to form uniform wall charge can be reduced. The movement of mobile metal ions in the dielectric film to the interface between the dielectric film and the protective film is suppressed, so that a change in the properties of the protective film can be prevented, leading to an improvement in reliability. In addition, the movement of mobile metal ions in the dielectric film can be minimized to prevent a variation in the operating point.

Furthermore, according to the present invention, the adjusting pulse is applied between the addressing operation and the sustaining operation to remove unnecessary wall charge and priming. It is thereby possible to avoid erroneous discharge at black level. In addition, by bringing the wall charge to an appropriate value, it is possible to realize a uniform luminous luminance of sustained discharge, and to thus reduce gradation-level errors in multiple-gradation-step display or the like.

While the preferred embodiments of the present invention have been described using the specific terms, such description is for illustrative purposes only, and it is to be understood that changes and variations may be made without departing from the spirit or scope of the following claims.

What is claimed is:

1. A plasma display apparatus comprising:
a panel including a dischargeable gas sealed between a pair of substrates joined to each other, a first electrode and a second electrode formed on one substrate in correspondence with each scanning line, and
a third electrode formed on the other substrate in correspondence with each data line; and
a driving unit for driving the first electrode, the second electrode, and the third electrode, sequentially writing data at an intersection of each scanning line and each data line and retaining the data at the intersection, and thereby displaying one field of image;
wherein said driving unit performs alternating-current driving by interchanging waveforms of driving signals applied to the first electrode and the second electrode between fields or within a field.

2. A plasma display apparatus as claimed in claim 1,
wherein said driving unit first applies the driving signals to the first electrode and the second electrode to reset the scanning line, then addresses the reset scanning line to write data therein, and thereafter retains the written data; and
the waveforms of the driving signals are interchanged at least at the times of resetting and addressing the scanning line.

3. A plasma display apparatus as claimed in claim 1,
wherein to write and retain multiple-gradation-step data formed by a plurality of weighted bits, said driving unit divides one field into a plurality of sub-fields corresponding to the plurality of bits; and
said driving unit performs the alternating-current driving by interchanging the waveforms of the driving signals applied to the first electrode and the second electrode in each of the sub-fields.

4. A driving method of a plasma display apparatus,
said plasma display apparatus having a panel including a dischargeable gas sealed between a pair of substrates joined to each other, a first electrode and a second electrode formed on one substrate in correspondence with each scanning line, and a third electrode formed on the other substrate in correspondence with each data line, and said plasma display apparatus driving the first electrode, the second electrode, and the third electrode, sequentially writing data at an intersection of each scanning line and each data line and retaining the data at the intersection, and thereby displaying one field of image, said driving method comprising:
interchanging waveforms of driving signals applied to the first electrode and the second electrode between fields or within a field and thereby performing alternating-current driving.

5. A plasma display apparatus comprising:
a panel including a dischargeable gas sealed between a pair of substrates joined to each other, a first electrode and a second electrode formed on one substrate in correspondence with each scanning line, and a third electrode formed on the other substrate in correspondence with each data line; and
a driving unit for driving the first electrode, the second electrode, and the third electrode, sequentially writing data at an intersection of each scanning line and each data line and retaining the data at the intersection, and thereby displaying an image;
wherein said driving unit applies driving signals to the first electrode and the second electrode, and thereby first performs a resetting operation for resetting scanning lines to write white level simultaneously, then performs an addressing operation for sequentially addressing each of the scanning lines to change the written white level to black level according to data, and thereafter performs a sustaining operation for retaining luminance corresponding to the written white level and black level; and
said driving unit applies a driving signal for discharge stabilization between the addressing operation and the sustaining operation.

6. A plasma display apparatus as claimed in claim 5,
wherein said driving unit applies the driving signal for discharge stabilization to only scanning lines in which the black level is written in the addressing operation.

7. A plasma display apparatus as claimed in claim 6,
wherein said driving unit applies the driving signal for discharge stabilization when luminance of the image is low, and doest not apply the driving signal for discharge stabilization when the luminance of the image is high.

8. A plasma display apparatus as claimed in claim 6,
wherein when contrast of the image is to be
said plasma display apparatus having a panel including a dischargeable gas sealed between a pair of substrates joined to each other, a first electrode and a second electrode formed on one substrate in correspondence with each scanning line, and a third electrode formed on the other substrate in correspondence with each data line, and said plasma display apparatus driving the first electrode, the second electrode, and the third electrode, sequentially writing data at an intersection of each scanning line and each data line and retaining the data at the intersection, and thereby displaying an image, said driving method comprising:
applying driving signals to the first electrode and the second electrode, and thereby performing a resetting operation first for resetting scanning lines to write white level simultaneously, then an addressing operation for sequentially addressing each of the scanning lines to change the written white level to black level according to data, and thereafter a sustaining operation for retaining luminance corresponding to the written white level and black level; and
applying a driving signal for discharge stabilization between the addressing operation and the sustaining operation.
